(19) United States
(12) Patent Application Publication
(10) Pub. No.: US 2008/0105658 A1
(43) Pub. Date: May 8, 2008

(54) Laser module with laser generator control switch

(75) Inventors: David M. Smith, Simpsonville, SC (US); Anthony M. Sorrells, Pickens, SC (US)

Correspondence Address: BRINKS HOFER GILSON & LIONE, P.O. BOX 10395, CHICAGO, IL, 60610, US

(73) Assignee: Eastway Fair Company Limited

(21) Appl. No.: 11/595,424

(22) Filed: Nov. 8, 2006

(51) Int. Cl. B26D 7/27; B23K 26/02; B23K 26/00

(52) U.S. Cl. 219/121.6; 83/521; 219/130.1

(57) ABSTRACT

A laser module for use with a rotating blade-type cutting device, such as a miter saw. The laser module includes a housing rotating in unison with the saw blade, a power source positioned within the housing for supplying electrical power to the laser generator, and a laser generator control switch selectively connecting the laser generator to the power source. For example, a first laser generator control switch may be a centrifugal switch electrically connecting the laser generator to the power source upon rotation of the laser module at a sufficient speed and a second laser generator control switch may be an on/off switch electrically connecting the laser generator to the power source when in a closed position.

The present invention relates to a laser module for a rotating blade-type saw, such as a miter saw. More specifically, the present invention relates to a laser module having laser generator control switch for activating a laser generator within the laser module.

### BACKGROUND OF THE INVENTION

Rotating saws, such as miter saws, are typically used to cut wood and other materials at precise lengths and angles. Miter saws generally include a base for supporting a workpiece to be cut, an arm extending upwardly from the base, and a saw head assembly pivotally connected to the arm. The saw head assembly includes a rotating spindle, a power source for driving the spindle, and a blade supported by the spindle so as to rotate in unison therewith. During use, the operator activates the power source to rotate the blade and lowers the saw head assembly towards the base, thereby cutting the area of workpiece between the blade cutting edges (commonly known as the kerf). When the cut is intended for a specific location along the workpiece, the operator typically marks the workpiece and attempts to align the saw blade with the mark before making the cut. To improve the alignment of the blade with respect to the mark on the workpiece, currently known saws often include laser alignment devices that project a laser beam onto the top surface of the workpiece.

### BRIEF SUMMARY OF THE INVENTION

The present invention includes a laser module for use with a rotating blade-type cutting device, such as a miter saw circular saw and the like. The laser module includes a housing rotating in unison with the saw blade, a power source positioned within the housing for supplying electrical power to the laser generator, and a laser generator control switch for selectively activating the laser generator.

In one aspect of the invention, the laser module includes two laser generator control switches: a centrifugal switch for selectively connecting the laser generator to the power source upon rotation of the laser module at a sufficient speed; and an on/off switch for selectively connecting the laser generator to the power source when in a closed position. The centrifugal switch and the on/off switch may be wired in parallel so that the centrifugal switch selectively completes a first electrical connection between the power source and the laser generator and the on/off switch selectively completes a second electrical connection between the power source and the laser generator.

In another aspect, the on/off switch includes a base secured to the housing and an actuator movably supported by the base. The actuator is movable between an open position, where the second electrical connection is not completed, and the closed position, where the second electrical connection is completed.

In yet another aspect, the centrifugal switch includes a metal casing secured to the housing and a flexible connector positioned within the casing. The flexible connector includes a spring secured to the housing and a metal head supported by the spring. The metal head is positioned within the metal casing so as to engage the wall of the casing upon rotation of the laser module at the sufficient speed and complete the first electrical connection.

In another aspect of the present invention, a laser generator, a power source, and a centrifugal switch are supported by the housing. Additionally, an on/off switch is positioned with respect to the centrifugal switch so as to urge a portion of the centrifugal switch into a closed position and electrically connect the laser generator to the power source. The on/off switch may include a first portion extending through an opening in the housing and a second portion selectively urging the flexible connector into engagement with the casing. The second portion of the on/off switch may include a tapered surface for urging the portion of the centrifugal switch into the closed position.

In yet another aspect of the present invention, a laser generator, a power source, and a laser generator control switch are supported by the housing, and the laser generator control switch includes a metal casing supported by the housing and a metal connector positioned within the casing. Upon rotation of the laser module at a sufficient speed, the metal connector selectively engages the metal casing to electrically connect the laser generator to the power source.

### BRIEF DESCRIPTION OF THE DRAWINGS

FIG. 1 is a partial cross-sectional view of a miter saw having a laser module embodying the principles of the present invention;

FIG. 2 is a top perspective of the laser module shown in FIG. 1;

FIG. 3a is a top perspective view of an inner cover of the laser module shown in FIG. 2;

FIG. 3b is a bottom perspective view of an inner cover of the laser module shown in FIG. 2;

FIG. 4 is a side perspective view of the inner cover of the laser module shown in FIG. 3;

FIG. 5 is a side perspective view of a flexure bracket shown in FIG. 4; and

FIG. 6 is a partial cross-sectional view of an on/off switch for a second embodiment of a laser module embodying the principles of the present invention.

### DETAILED DESCRIPTION OF THE INVENTION

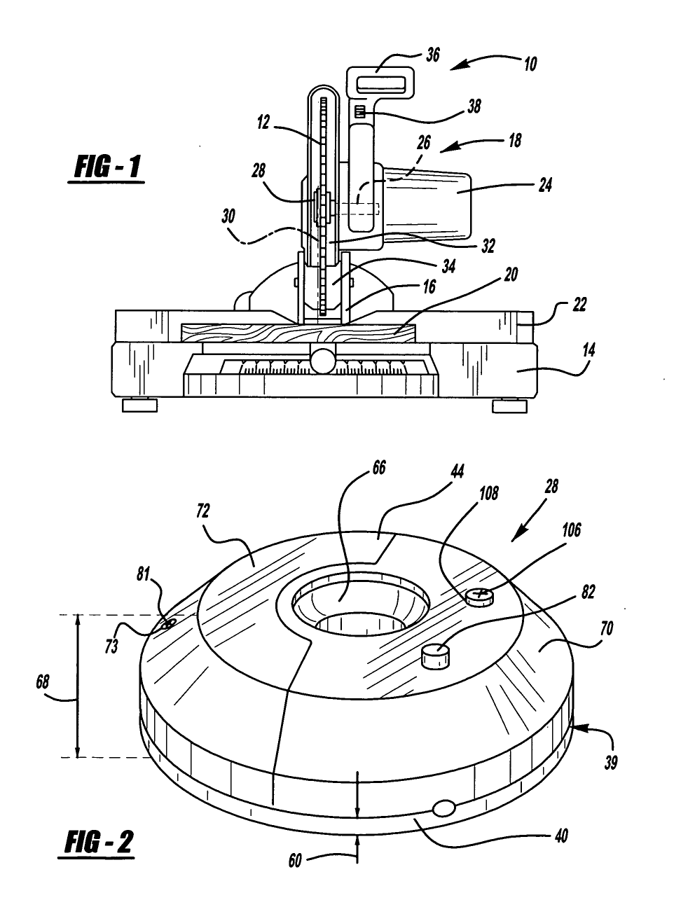

Referring now to the drawings and initially to FIG. 1, a rotating blade-type cutting device, such as a miter saw 10 is shown. The miter saw 10 generally includes a base 14, an arm 16 extending upwards from the base 14, and a saw head assembly 18 pivotally supported by the arm 16 and configured to rotate a saw blade 12 with respect to the base 14. The base 14 includes a flat surface for supporting a workpiece 20 and a fence 22 against which the workpiece 18 may be held in a desired position, such as perpendicular to the saw blade 12. The saw head assembly 18 includes a motor assembly 24, a shaft 26 rotated by the motor assembly 24, a laser module 28 for mounting the circular saw blade 12 to the shaft 26 and projecting an indicator beam 30 toward the workpiece 20, a fixed guard 32 and a movable shield 34 generally positioned around the saw blade 12 for shielding purposes, a handle 36 for moving the saw head assembly 18 with respect to the arm 16, and a power switch 38 for activating the motor assembly 24. The pivotable connection between the saw head assembly 18 and the arm 16 may include a spring (not shown) for biasing the saw head assembly 18 out of engagement with the workpiece 20. Although the saw 10 shown in FIG. 1 is a compound miter saw having a miter angle adjustment mechanism and a tilt adjustment mechanism, the invention is equally applicable to any other suitable cutting device such as a simple miter saw, a sliding compound miter saw, a chop saw, or the like.

During operation, when ready to make a cut, the operator grips the handle 36 and lowers the saw head assembly 18 down toward the workpiece 20 while depressing the power switch 38 and actuating the motor assembly 24. When the saw head assembly 18 is lowered to a sufficient position, the rotating saw blade 12 cuts the workpiece 20.

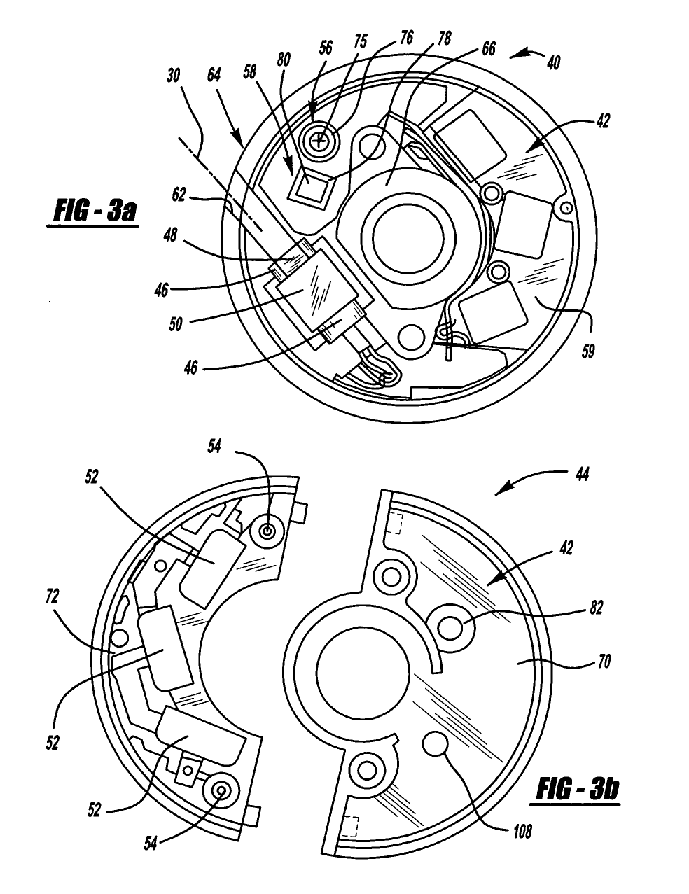

Referring now to FIGS. 2, 3a, and 3b, the laser module 28 includes a housing 39 having an inner cover 40 with a surface adjacent a face of the saw blade 12 and a two-piece outer cover 44 that cooperates with the inner cover 40 to define a cavity 42 for housing the components of the laser module 28. For example, referring to FIGS. 3a and 3b, the laser module 28 includes the following components: a laser generator 46 that emits light, a lens 48 for focusing the light into the indicator beam 30, a flexure bracket 50 for adjustably supporting the laser generator 46 within the cavity 42, a plurality of batteries 52 and electrical connectors 54 for supplying electricity to the laser generator 46, and one or more laser generator control switch, such as a centrifugal switch 56 and an on/off switch 58, for selectively activating the laser generator 46.

The inner cover 40 may be made of any suitable material but is generally made of metal. The inner cover 40 includes a blade washer portion 59 that engages a face of the saw blade 12 and a central hub 66 extending from the blade washer portion 59. The blade washer portion 59 of the inner cover 40 has a relatively small thickness 60 to minimize the lateral distance between the indicator beam 30 and the face of the saw blade 12. Furthermore, the blade washer portion 59 of the inner cover 40 includes a laser beam channel 62 extending from the lens 48 to a perimeter 64 of the inner cover 40 to further reduce the lateral distance between the indicator beam 30 and the face of the saw blade 12. This configuration permits the indicator beam 30 to be substantially parallel to the face of the saw blade 12 when intersecting the workpiece 20. The central hub 66 extends substantially completely across the thickness 68 of the laser module 28 to strengthen the laser module 28. More specifically, when the laser module 28 is mounted to the saw blade 12 the central hub 66 completely bears the compression forces acting on the laser module 28 and prevents the plastic outer cover 44 and the components 46-58 within the cavity 42 from experiencing such forces. More specifically, a mounting bolt or a shoulder portion of the shaft 26 abuts a top collar of the central hub 66 to secure the laser module 28 to the saw blade 12.

As shown in FIG. 3b, the outer cover 44 is a two-piece cover having a laser cover 70 positioned over the laser generator 46 and a battery cover 72 positioned over the batteries 52. The laser cover 70 and the battery cover 72 are each independently connected to the inner cover 40 so that the battery cover 72 is removable from the inner cover 40 without requiring the removal of the laser cover 70 and without dismounting of the laser module 28 from the saw blade 12. This configuration simplifies access to the batteries 52 and reduces the time and effort required to replace the batteries 52.

As mentioned above, the laser generator 46 and the lens 48 cooperate to generate a dot-like laser beam that is emitted from the laser module 28 as the indicator beam 30. As a result of the rotation of the laser module 28, the indicator beam 30 appears as an indicator line (not shown) extending across a top surface of the workpiece 20 in a direction that is parallel to the saw blade 12. The laser generator 46 is connected to the inner cover 40 by the flexure bracket 50. The flexure bracket 50 is flexible to permit adjustment of the alignment of the indicator beam 30, as will be discussed in further detail below. Although a laser generator is disclosed in the figures, any suitable light source may be used to generate the indicator line on the workpiece, such as a light emitting diode (LED) or a focused electric light bulb.

The batteries 52 are relatively small, such as the type of batteries that would be suitable for a wrist watch, and are spaced from each other such that the weight of the laser module 28 is substantially balanced. The batteries 52 and the electrical connectors 54 define an electrical circuit that is selectively closed by the centrifugal switch 56 and/or the on/off switch 58. In an alternative design, another type of electrical power supply may be used, such as an electromagnetic generator that utilizes the rotational motion of the laser module 28 to generate power.

The centrifugal switch 56 and the on/off switch 58 are each wired in series with the batteries 52 and the laser generator 46 so that the laser generator 46 is only activated when one or both of the switches 56, 58 is in a closed position. The centrifugal switch 56 includes a flexible connector 73 positioned within a cylindrical metal casing 76 in such a manner that the flexible connector 73 does not engage the walls of the casing 76 when in an undeflected position. For example, the flexible connector includes a spring 74 having a first end connected to the inner cover 40 and a second end supporting a metal head 75 that selectively engages the casing 76. More specifically, the spring 74 is generally axially centered within the casing 76 so that the metal head 75 does not engage the walls of the casing when the spring 74 is in the undeflected position. However, upon rotation of the laser module 28, centrifugal forces cause the spring 74 to deflect and the metal head 75 to engage the walls of the casing 76, thereby closing the centrifugal switch 56 and completing the electrical circuit between the batteries 52 and the laser generator 46. The centrifugal switch 56 reduces the likelihood of accidental activation of the laser generator 46, thereby increasing the battery life and potentially reducing the likelihood of laser-related injuries.

Because the position of the laser generator 46 can only be adjusted while the laser module 28 is stationary, as will be discussed in more detail below, the on/off switch 58 is provided to selectively activate the laser generator 46 when the laser module 28 is stationary. The on/off switch 58 includes a housing 78 connected to the inner cover 40, an actuator 80 slidably positioned within the housing 78 so as to be movable between contracted and extended positions, a spring (not shown) to urge the actuator 80 towards the extended position, and a rubber cap 82 positioned on the top of the actuator 80 and extending through an opening in the outer cover 44 so as to be accessible to the saw operator. The bottom of the actuator 80 includes a metal connector so that the on/off switch 58 is open when the actuator 80 is in the extended position and is closed when the actuator 80 is in the contracted position. The on/off switch 58 is connected in parallel with the centrifugal switch 56 so that the closure of either switch 56, 58 completes the electrical circuit between the batteries 52 and the laser generator 46. More specifically, the centrifugal switch 56 completes a first electrical connection between the batteries 52 and the laser generator 46 and the on/off switch 58 completes a second electrical connection between the batteries 52 and the laser generator 46.

As mentioned above, the laser generator 46 is connected to the inner cover 40 by the flexure bracket 50, which is flexible so that the alignment of the laser generator 46 is adjustable with respect to the housing 39. This configuration permits the saw operator to properly align the location of the indicator line on the workpiece 20 with respect to the saw blade 12 and the kerf.

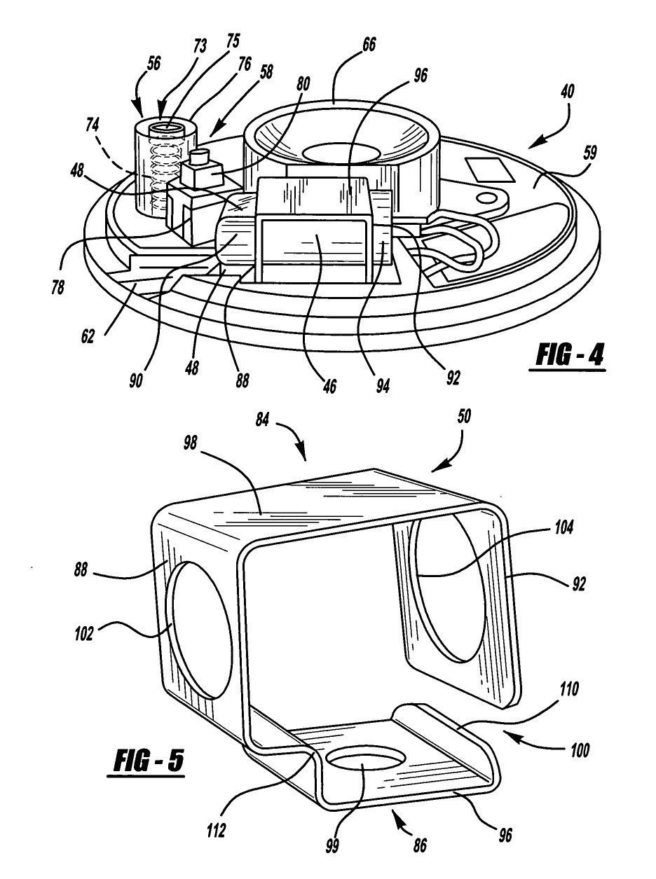

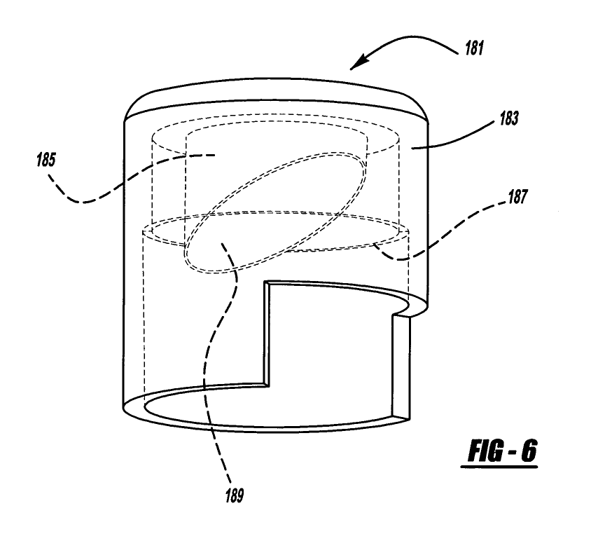

Referring to FIGS. 4 and 5, the flexure bracket 50 in one embodiment includes a support portion 84 supporting the laser generator 46 and a connector portion 86 connected to the inner cover 40. The support portion 84 is movable with respect to the connector portion 86 so that the alignment of the laser generator 46 can be adjusted with respect to the housing 39. For example, the support portion 84 includes: a first arm 88 supporting one end portion 90 of the laser generator 46, a second arm 92 supporting the other end portion 94 of the laser generator 46, and a third arm 98 connecting the first and second arms 88, 92 with each other. The connector portion 86 includes a fourth arm 96 connected to the first arm 84 and to the inner cover 40. However, the second arm 92 only extends a portion of the distance between the third and fourth arms 98, 96 so that a gap 100 exists between the second and fourth arms 92, 96 and the support portion 84 and connector portion 86 are movable with respect to each other. The first and second arms 88, 92 are generally parallel with each other and the third and fourth arms 98, 96 are generally parallel with each other so that the flexure bracket 50 is a substantially closed, rectangular shape.

As mentioned above, the first arm 88 supports one end 90 of the laser generator 46 and the second arm 92 supports the other end 94 of the laser generator 46. This configuration maximizes the distance between the first and second arms 88, 92 and provides stability between the points of connection for the laser generator 46 so that the location of the indicator line on the workpiece 20 remains substantially constant unless the flexure bracket 50 is actively adjusted.

Each of the first and second arms 88, 92 include an opening 102, 104 for receiving a respective end portion 90, 94 of the laser module 46. The laser generator 46 may be press-fit within the respective openings 102, 104. An additional securing means, however, such as an epoxy material or a mechanical fastener, may be provided between the respective components 46, 50. Additionally, the fourth arm 96 includes an opening 99 for mounting the fourth arm 96 to the inner cover 40 with a mechanical fastener or with another type of securing means such as an epoxy material.

An adjustment screw 106 extends through the outer cover 44 and is in threaded engagement with an opening 108 defined by the outer cover 44. The adjustment screw 106 abuts the third arm 98 of the flexure bracket 50 to control the position thereof. Therefore, rotation of the adjustment screw 106 adjusts the depth of the adjustment screw 106 within the laser module 28 and the alignment of the laser generator 46 with respect to the housing 39. More specifically, as the adjustment screw 106 is advanced into the housing 39, the gap 100 between the second and fourth arms 92, 96 of the flexure bracket becomes smaller and the path of the indicator beam 30 becomes angled outwardly, in a direction away from the saw blade 12. Therefore, the location of the indicator line on the workpiece 20 can be adjusted with respect to the saw blade 12 by rotating the adjustment screw 106. The operator is therefore able to adjust the indicator line to lie on a desired point of the workpiece 20, such as along the kerf or between the respective kerf.

The flexure bracket 50 may be made of a sheet metal material that is designed to permit flexing upon movement of the adjustment screw 106 and to prevent flexing when the adjustment screw 106 is not moving. Additionally, the fourth arm 98 includes a stop portion 110 to limit the range of motion of the second arm and a step portion 112 to promote flexing at the base of the first arm 88 upon movement of the adjustment screw 106. Furthermore, the adjustment screw 106 includes a means for facilitating rotation, such as a head portion that mates with a screwdriver or an allen wrench.

Referring now to FIG. 6, a laser generator control switch for a second embodiment of a laser module will now be discussed. The laser generator control switch shown in FIG. 6 is an on/off switch 181 made of a flexible material, such as rubber, and is configured to selectively close the centrifugal switch 56 and electrically connect the laser generator 46 to the batteries 52. As with the on/off switch 58 discussed above, the on/off switch 181 in FIG. 6 is able to selectively activate the laser generator 46 when the laser module is not rotating. However, unlike the on/off switch 58, discussed above, the on/off switch 181 shown in FIG. 6 is designed to physically urge the centrifugal switch 56 into a closed position, rather than to bypass the centrifugal switch 56 with a second electrical connection.

The on/off switch 181 includes a body portion 183 that extends through the opening 108 in the outer cover 44 (FIG. 2) and a protrusion 185 positioned within the body portion 183 and extending downward from an upper surface of the body portion 183 so as to selectively urge the metal head 75 into engagement with the casing 76. The body portion 183 of the on/off switch 181 is positioned over the casing 76 such that the inner wall of the body portion 183 engages the outer wall of the casing 76 in a relatively snug manner. The on/off switch 181 also includes a ridge 187 that engages the top surface of the casing 76 and prevents the on/off switch from completely sliding down the length of the casing 76. The protrusion 185 includes a tapered surface 189 that engages the metal head 75 upon depression of the on/off switch 181 and urges the metal head 75 into contact with the casing 76 inner walls, thereby completing the electrical connection between the batteries 52 and the laser generator 46. More specifically, the top portion of the on/off switch 181 is generally flexible so that, when depressed by the saw user, the top wall deflects downward and the protrusion 185 engages the metal head 75 and urges it towards the casing 76 inner wall to close the centrifugal switch 56. When the user releases the top portion of the on/off switch 181, the top wall deflects upward and the metal head 75 is able to move back towards its natural, undeflected position, to open the centrifugal switch 56.

While the invention has been described in conjunction with specific embodiments it is to be understood that many alternatives, modifications, and variations will be apparent to those skilled in the art in light of the foregoing detailed description. It is therefore intended that the foregoing description be regarded as illustrative rather than limiting, and that it be understood that it is the following claims, including all equivalents, that are intended to define the spirit and scope of this invention.

What is claimed:

1. A laser module for use with a cutting device having a rotating saw blade, the laser module comprising:
a housing mounted so that the housing and the saw blade rotate in unison;
a laser generator supported by the housing and configured to emit a laser beam from the housing;
a power source supported by the housing and configured to supply electrical power to the laser generator;
a first laser generator control switch supported by the housing and configured to electrically connect the laser generator to the power source upon rotation of the laser module at a sufficient speed; and
a second laser generator control switch configured to electrically connect the laser generator to the power source when in a closed position.

2. The laser module of claim 1, the first laser generator control switch including a centrifugal switch configured to electrically connect the laser generator to the power source upon rotation of the laser module at the sufficient speed.

3. The laser module of claim 2, the second laser generator control switch including an on/off switch configured to electrically connect the laser generator to the power source when in the closed position.

4. The laser module of claim 3, the on/off switch electrically wired in parallel with the centrifugal switch so that the centrifugal switch selectively completes a first electrical connection between the power source and the laser generator and the on/off switch selectively completes a second electrical connection between the power source and the laser generator.

5. The laser module of claim 4, the on/off switch including a base secured to the housing and an actuator movably supported by the base.

6. The laser module of claim 5, the actuator movable between an open position and the closed position where the second electrical connection is completed.

7. The laser module of claim 6, the on/off switch further including a cap generally aligned with the actuator and configured to extend through an opening in the housing.

8. The laser module of claim 5, the centrifugal switch including a metal casing secured to the housing and a flexible connector positioned within the casing.

9. The laser module of claim 8, the flexible connector configured to engage a wall of the casing and complete the first connection when the laser module rotates at the sufficient speed.

10. The laser module of claim 9, the flexible connector including a spring secured to the housing and a metal head supported by the spring and configured to engage the wall of the casing when the laser module rotates at the sufficient speed.

11. A laser module for use with a cutting device having a rotating saw blade, the laser module comprising:
a housing mounted so that the housing and the saw blade rotate in unison;
a laser generator supported by the housing and configured to emit a laser beam from the housing;
a power source supported by the housing and configured to supply electrical power to the laser generator;
a first laser generator control switch supported by the housing and configured to electrically connect the laser generator to the power source upon rotation of the laser module at a sufficient speed; and
a second laser generator control switch configured to selectively urge a portion of the first laser generator control switch into a closed position and electrically connect the laser generator to the power source.

12. The laser module of claim 11, the first laser generator control switch including a centrifugal switch configured to electrically connect the laser generator to the power source upon rotation of the laser module at the sufficient speed.

13. The laser module of claim 12, the second laser generator control switch including an on/off switch configured to selectively urge the portion of the first laser generator control switch into the closed position.

14. The laser module of claim 13, the centrifugal switch including a metal casing secured to the housing and a flexible connector positioned within the casing.

15. The laser module of claim 14, the flexible connector configured to engage a wall of the casing and complete the first connection when the laser module rotates at the sufficient speed.

16. The laser module of claim 15, the flexible connector including a spring secured to the housing and a metal head supported by the spring and configured to engage the wall of the casing when the laser module rotates at the sufficient speed.

17. The laser module of claim 16, the on/off switch generally aligned with the head of the centrifugal switch and configured to extend through an opening in the housing.

18. The laser module of claim 14, the on/off switch including a first portion configured to extend through an opening in the housing and a second portion configured to urge the flexible connector into engagement with the casing.

19. The laser module of claim 18, the second portion defining a tapered surface configured to engage the flexible connector.

20. The laser module of claim 14, the flexible connector including a spring secured to the housing and a metal head supported by the spring and configured to selectively engage a wall of the casing.

21. A laser module for use with a cutting device having a rotating saw blade, the laser module comprising:
a housing mounted so that the housing and the saw blade rotate in unison;
a laser generator supported by the housing and configured to emit a laser beam from the housing;
a power source supported by the housing and configured to supply electrical power to the laser generator; and
a laser generator control switch including a metal casing supported by the housing and a metal connector positioned within the casing, wherein the metal connector is configured to selectively engage the metal casing and electrically connect the laser generator to the power source upon rotation of the laser module at a sufficient speed.

22. The laser module of claim 21, the laser generator control switch further including a flexible member positioned within the casing and configured to support the metal connector.

23. The laser module of claim 22, the flexible connector including a spring having a first end secured to the housing and a second end configured to support the metal connector.
